(19) United States
(12) Patent Application Publication
(10) Pub. No.: US 2023/0284599 A1
(43) Pub. Date: Sep. 14, 2023

(54) OXALIC ACID VAPORIZER HAVING AN EFFICIENT DELIVERY OUTPUT FOR USE WITH A HIVE-MOUNTED VAPORIZER ADAPTER PLATE

(71) Applicant: Robert Earl Pollock, IV, Baltimore, MD (US)

(72) Inventor: Robert Earl Pollock, IV, Baltimore, MD (US)

(21) Appl. No.: 17/690,675

(22) Filed: Mar. 9, 2022

(51) Int. Cl. A01K 51/00; A01K 47/06

(52) U.S. Cl. CPC A01K 51/00; A01K 47/06

(57) ABSTRACT

Disclosed is an efficient delivery output, for an oxalic acid vaporizer, for use with a hive-mounted vaporizer adapter device to more uniformly distribute hot vapor into an interior of a beekeeping device. The efficient delivery output includes an output body having a proximal end and a distal end, and an oxalic acid vapor passageway extending between the proximal end and the distal end; wherein the proximal end is configured to direct and concentrate oxalic acid vapors received from an oxalic acid reservoir of the oxalic acid vaporizer; and the distal end is configured to deliver the concentrated oxalic acid vapors to a central area of the beekeeping device. The vaporizer adapter device engages with a beekeeping hive. The adapter device includes an adapter body (e.g., a flat plate) having at least one hive engagement feature (e.g., side edges of the plate); at least one manipulation feature (e.g., a lip for gripping a front of the plate); and a recess for providing a reservoir (e.g., a space for the hot acid vapor to gather) below the hive, the reservoir being open to an interior of the hive, the recess including a port (e.g., a through hole) configured to accommodate the efficient delivery output.

### FIELD OF THE INVENTION

The present general inventive concept relates to oxalic acid vaporizers for treating beehives, and more particularly to oxalic acid vaporizers having efficient delivery outputs for use with hive-mounted vaporizer adapter plates configured to protect beehives from hot vapor treatments.

### BACKGROUND OF THE INVENTION

Beekeeping devices such as artificial beehives, bee boxes, and the like require treatment to kill varroa mites. The treatment is typically accomplished by using an external vaporizer to heat oxalic acid to a vapor and directing the acid vapor into the beekeeping device. The acid vapors kill the varroa mites.

Such beekeeping devices are typically made of wood or plastic. The wooden beekeeping devices are not adversely affected by the hot stem of the vaporizer output. However, plastic beekeeping devices will melt or singe. Therefore, there is a need for enabling use of an oxalic acid vaporizer with plastic beekeeping devices.

In addition, a more uniform distribution of oxalic vapor within such beekeeping devices provides a more effective and thorough treatment to eradicate varroa mites. Therefore, there is also a need for enabling an oxalic acid vaporizer to efficiently direct hot vapor into an interior of a beekeeping device.

### SUMMARY OF THE INVENTION

Certain of the foregoing and related aspects are readily attained according to the present general inventive concept by providing an oxalic acid vaporizer having an efficient delivery output for use with a hive-mounted vaporizer adapter device configured to protect beehives from hot vapor treatments.

In example embodiments of the present general inventive concept, the invention provides an efficient delivery output, for an oxalic acid vaporizer, for use with a hive-mounted vaporizer adapter device to more uniformly distribute hot vapor into an interior of a beekeeping device. An example of a vaporizer adapter device for a beekeeping device with which the present inventive efficient delivery output can be used includes an adapter body (e.g., a flat plate) having at least one hive engagement feature (e.g., side edges of the plate); at least one manipulation feature (e.g., a lip for gripping a front of the plate); and a recess for providing a reservoir (e.g., a space for the hot acid vapor to gather) below the hive, the reservoir being open to an interior of the hive, the recess including a port (e.g., a through hole) configured to accommodate a vaporizer output (e.g., a tube) of a vaporizer. Embodiments of the present inventive efficient delivery output that are accommodated by the example vaporizer adapter device will be described in detail below.

In the example vaporizer adapter device, a hive with which the vaporizer adapter device can be used has lateral protrusions (e.g., ledges), and the hive engagement feature includes lateral edges that slidably engage with the protrusions. The protrusions extend inwardly (e.g., the ledges extend inwardly from interior walls of the hive bottom), and the edges slide on the protrusions (e.g., the plate edges slide along the ledges to support the plate when installed). Further, the adapter body is planar, the edges extend non-parallel to the adapter body (e.g., bend downward relative to the body of the plate), and ends of the edges (e.g., downwardly extending ends of the edges) slide on the protrusions.

In the example vaporizer adapter device, the manipulation feature includes a lip that extends outwardly from the hive (e.g., is outside the hive) when the device is installed in the hive. The adapter body is planar and the lip extends non-parallel to the body (e.g., bends upwards and away from the body of the plate).

In the example vaporizer adapter device, the reservoir has a pyramid shape with a base of the pyramid shape being open to the interior of the hive. The pyramid shape is a triangular pyramid shape. The base of the triangular pyramid shape is an isosceles triangle. However, the reservoir can be any suitable shape.

In the example vaporizer adapter device, the port includes a hole (e.g., a through hole) leading from an exterior surface of the recess to an interior surface of the recess. It is with this port that preferred embodiments of the present inventive efficient delivery output preferably engage when accommodated by the example vaporizer adapter device, as will be described in detail below.

In operation, the example vaporizer adapter device is installed by engaging the hive engagement feature of the adapter body with the hive using the hive manipulating feature to install the vaporizer adapter device in the hive such that the reservoir is open to an interior of the hive. Then, a vaporizer output of a vaporizer is passed through the port and the vaporizer is operated to apply the treatment such that the hot acid vapors gather in the reservoir and pass into the interior of the hive, killing any varroa mites. With regard to the present inventive efficient delivery output, preferred embodiments of the output can be passed through the port and accordingly when the vaporizer is operated as described, the hot acid vapors are more uniformly distributed, as will be described in detail below.

In an example operation, the example vaporizer adapter device is installed by sliding the lateral edges of the adapter plate onto the lateral protrusions of the hive using the lip of the adapter plate to install the vaporizer adapter device in the hive at the hive bottom such that the reservoir is open from above to an interior of the hive. Then, a vaporizer output of a vaporizer is passed through the port and the vaporizer is operated to apply the treatment such that the hot acid vapors gather in the reservoir and then pass upwardly into the interior of the hive, killing any varroa mites. With regard to the present inventive efficient delivery output, preferred embodiments of the output can be passed through the port and accordingly when the vaporizer is operated as described, the hot acid vapors are more uniformly distributed, as will be described in detail below.

In other example embodiment of the present general inventive concept, the invention provides an oxalic acid vaporizer that includes an efficient delivery output of a type discussed above, for use with such an example hive-mounted vaporizer adapter device, to more uniformly distribute hot vapor into an interior of a beekeeping device.

It should be understood that the efficient delivery output of the present invention can be a separate device that is attached to or otherwise cooperates with an oxalic acid vaporizer, but can alternatively be in whole or in part integrated into an oxalic acid vaporizer or other vaporizers.

It should be understood that the example vaporizer adapter device can be a separate device that is installed in a beekeeping device or otherwise cooperates with a beekeeping hive, but can alternatively be in whole or in part integrated into a beekeeping device or beekeeping hive.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a front perspective view of a beekeeping hive with an example vaporizer adapter plate installed in the hive, the plate having a port for engagement with an efficient delivery output according to an example of the present general inventive concept.

FIG. 2 is a front upside-down perspective view of the example vaporizer adapter plate shown in FIG. 1.

FIG. 3 is a front upside-down view of the example vaporizer adapter plate of FIG. 1;

FIG. 4 is a back upside-down view of the example vaporizer adapter plate of FIG. 1;

FIG. 5 is a bottom view of the example vaporizer adapter plate of FIG. 1;

FIG. 6 is a top view of the example vaporizer adapter plate of FIG. 1;

FIG. 7 is a schematic representation view of the example vaporizer adapter plate of FIG. 1;

FIG. 8 is a bottom left side perspective partial assembly view of the example vaporizer adapter plate of FIG. 1;

FIG. 9 is a bottom right side perspective partial view of the example vaporizer adapter plate of FIG. 1.

FIG. 10 is a bottom left side perspective partial view of the example vaporizer adapter plate of FIG. 1.

FIG. 11 is a bottom perspective view of the example vaporizer adapter plate of FIG. 1.

FIG. 12 is a front perspective view of the beekeeping hive of FIG. 1 with the example vaporizer adapter plate of FIG. 1 installed in the hive.

FIG. 13 is a front perspective view of the beekeeping hive of FIG. 1 with the example vaporizer adapter plate of FIG. 1 partially installed in the hive.

FIG. 14 is a side perspective view of the beekeeping hive of FIG. 1 with the example vaporizer adapter plate of FIG. 1 partially installed in the hive.

FIG. 15 is a front perspective view of the beekeeping hive of FIG. 1 with the example vaporizer adapter plate of FIG. 1 powder coated and installed in the hive.

FIG. 16 is a front perspective view of the beekeeping hive of FIG. 1 with the example vaporizer adapter plate of FIG. 1 powder coated and partially installed in the hive.

FIG. 17 is a side perspective view of a vaporizer, for a beekeeping hive, having an efficient delivery output according to an example of the present general inventive concept.

FIG. 18 is a front perspective view of the beekeeping hive of FIG. 1 with the example vaporizer adapter plate of FIG. 1 powder coated and installed in the hive, with the vaporizer of FIG. 17 with its efficient delivery output fitted within a port of the example vaporizer adapter plate.

FIG. 19 is a right side view of the vaporizer of FIG. 17.

FIG. 20 is a left side view of the vaporizer of FIG. 17.

FIG. 21 is a back perspective view of the vaporizer of FIG. 17.

FIG. 22 is a front close-up view of the vaporizer of FIG. 17, showing its efficient delivery output.

### DESCRIPTION OF EXAMPLE EMBODIMENTS

The present inventive concept will now be described more fully with reference to the accompanying drawings, in which exemplary embodiments of the present general inventive concept are illustrated. The inventive concept may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals refer to like elements throughout.

### Efficient Delivery Output Embodiments

In example embodiments of the present general inventive concept, the invention provides an efficient delivery output, for an oxalic acid vaporizer, for use with a hive-mounted vaporizer adapter device to more uniformly distribute hot vapor into an interior of a beekeeping device.

While the present general inventive concept can be used with the example hive-mounted vaporizer adapter device described herein, it should be understood that the present general inventive concept can be used with any hive-mounted vaporizer adapter device having a suitably configured vaporizer output port, or any beekeeping device having an integrated suitably configured vaporizer output port.

While the present general inventive concept can be used with any beekeeping device having a cooperating vaporizer output port (whether directly integrated with the beekeeping device or by way of a separately mounted hive-mounted vaporizer adapter device for the beekeeping device), typically beekeeping devices are artificial beehives, bee boxes, and the like.

Preferred embodiments of the efficient delivery output of the present invention will now be described with reference to the aforementioned example vaporizer adapter device.

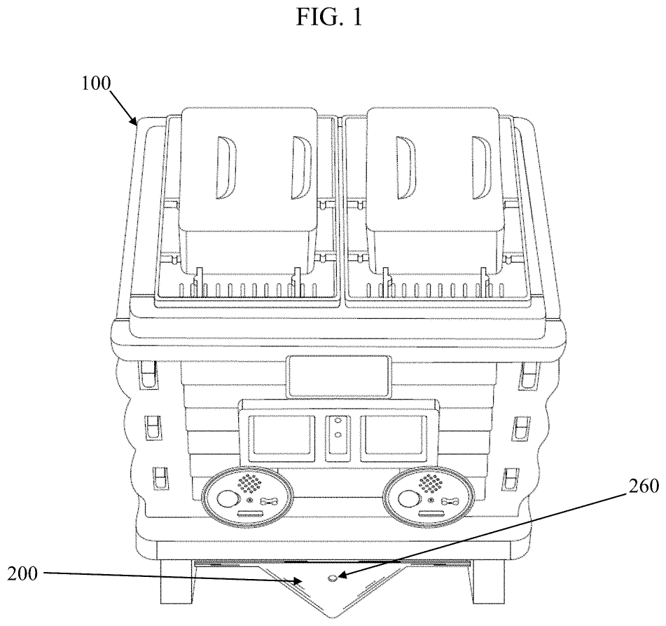

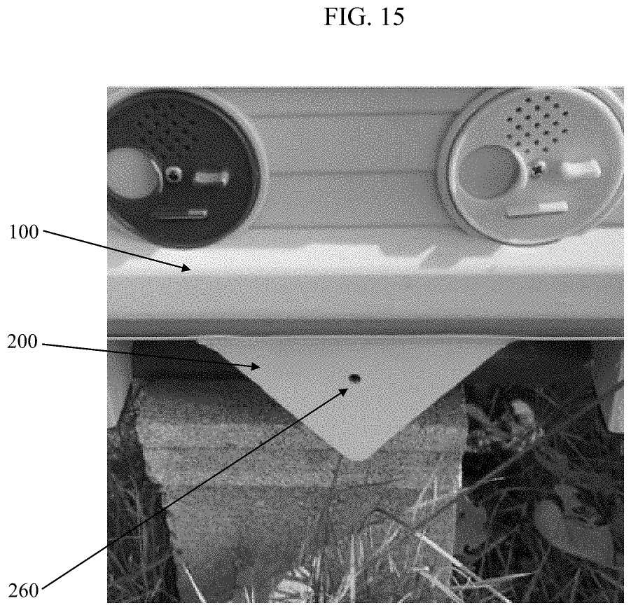

Referring now to FIGS. 1, 12, 15 and 18, an example vaporizer adapter device 200, for a beekeeping hive 100, is illustrated installed in the hive 100.

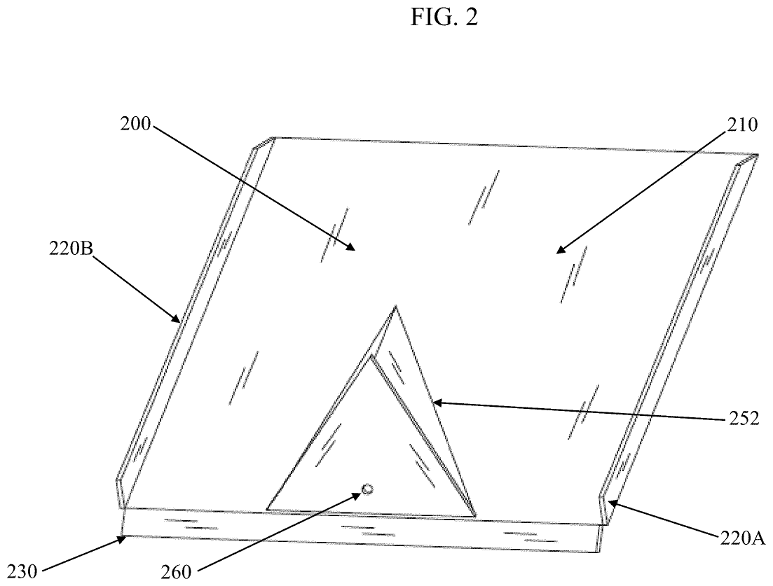

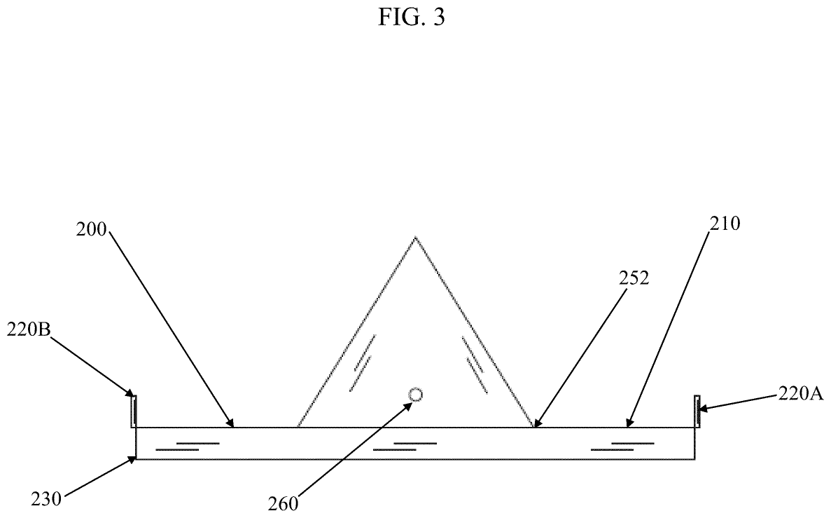

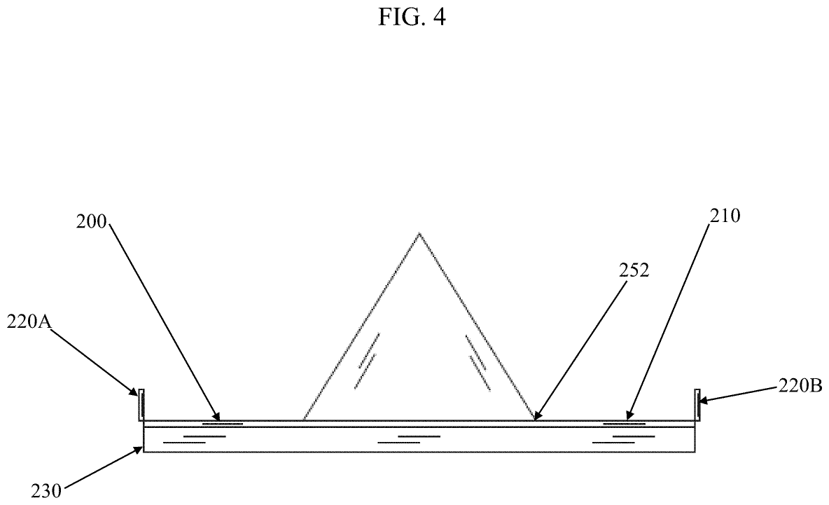

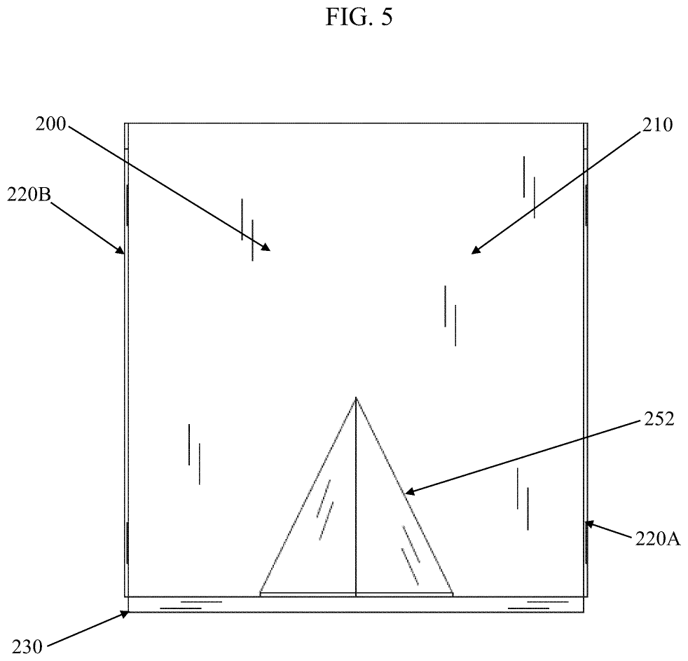

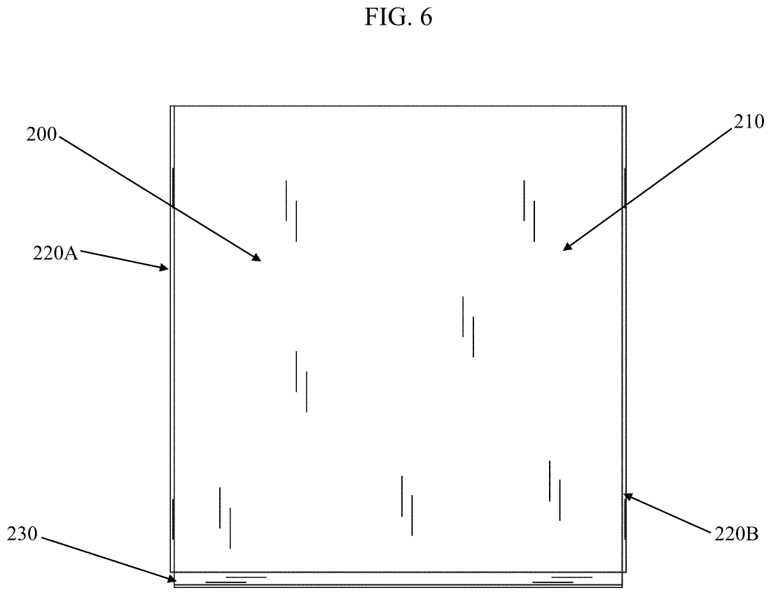

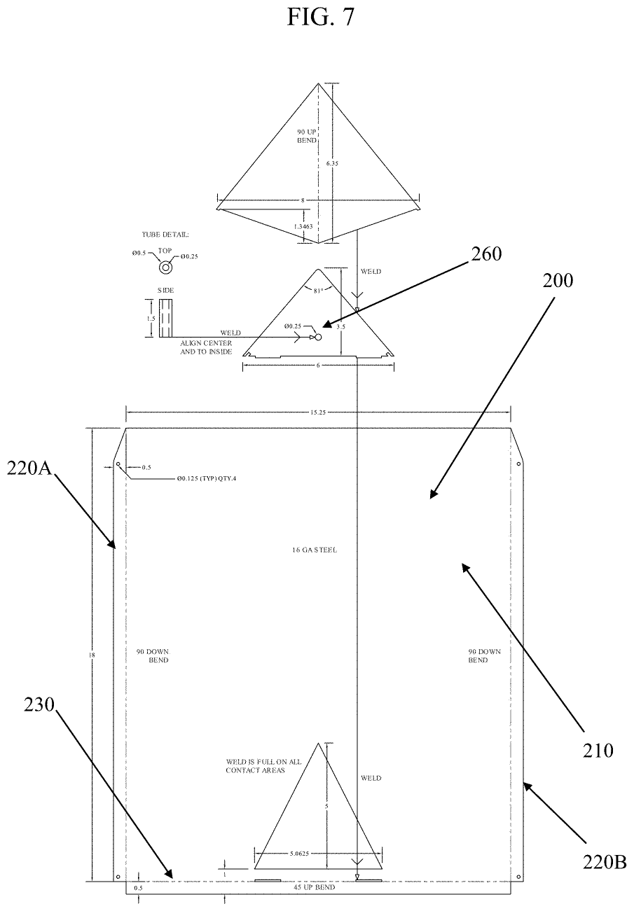

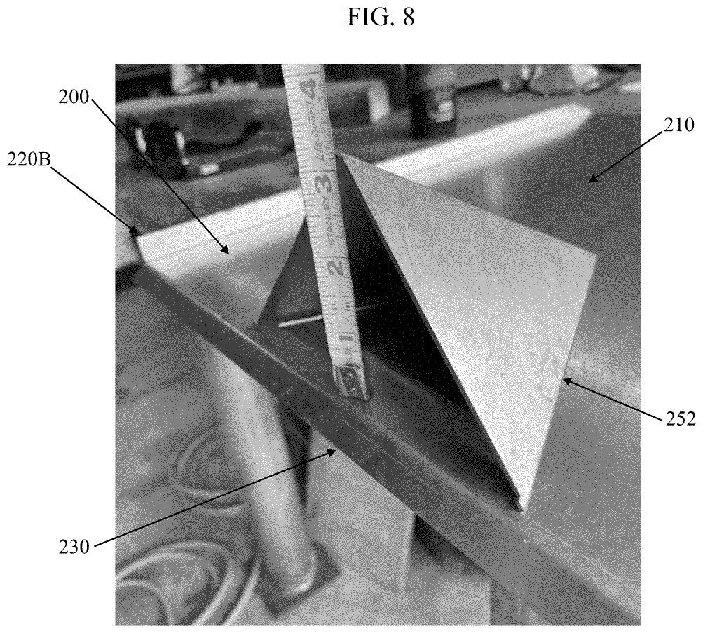

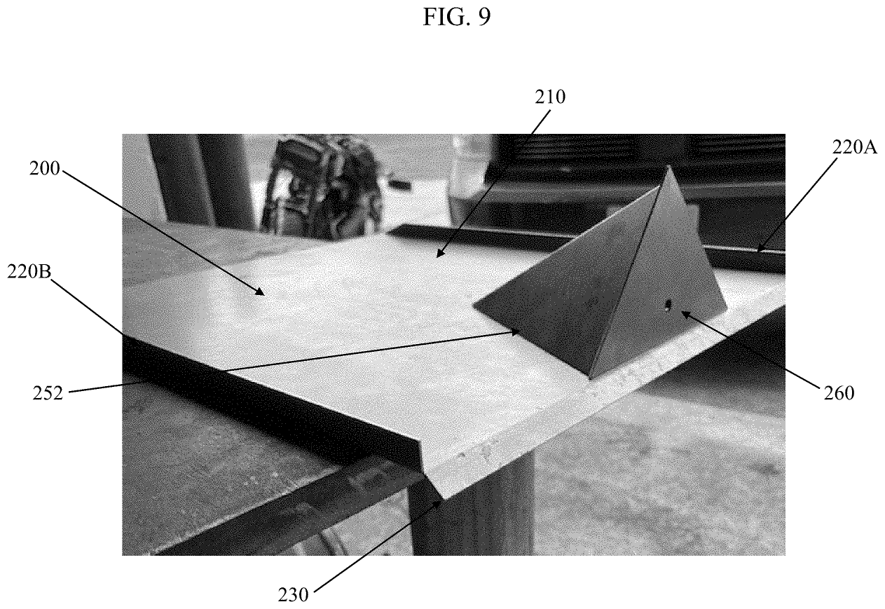

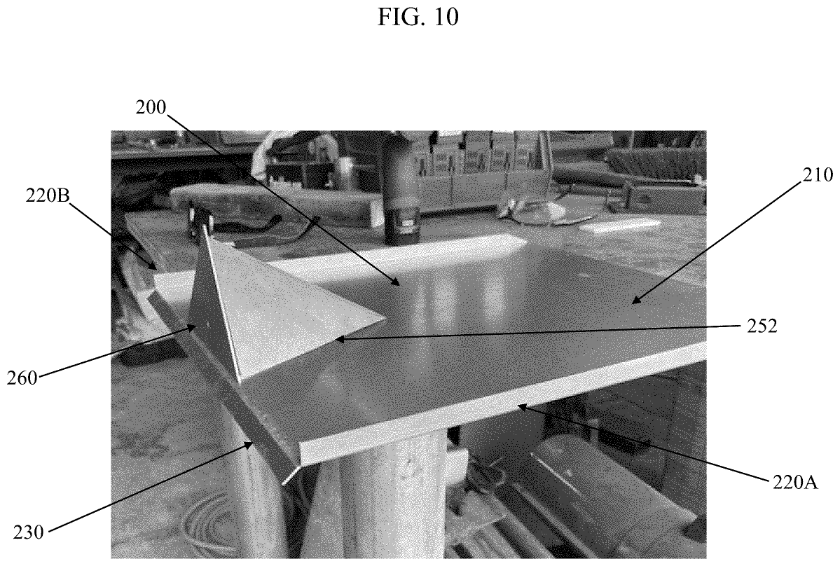

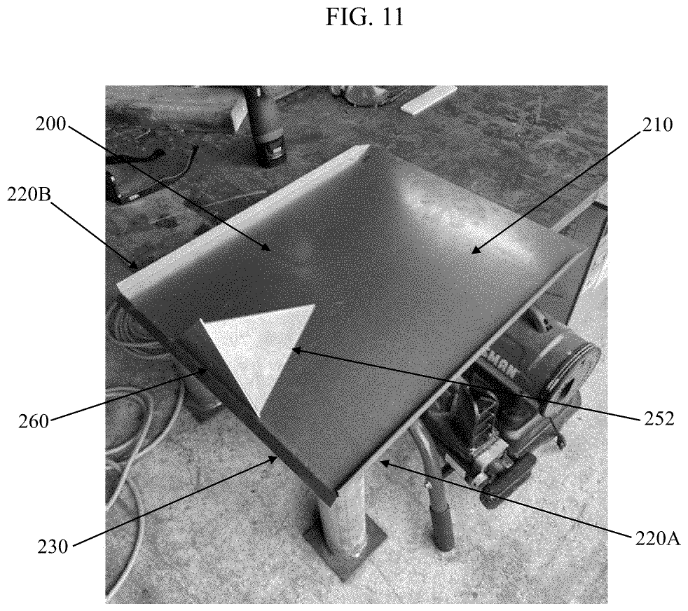

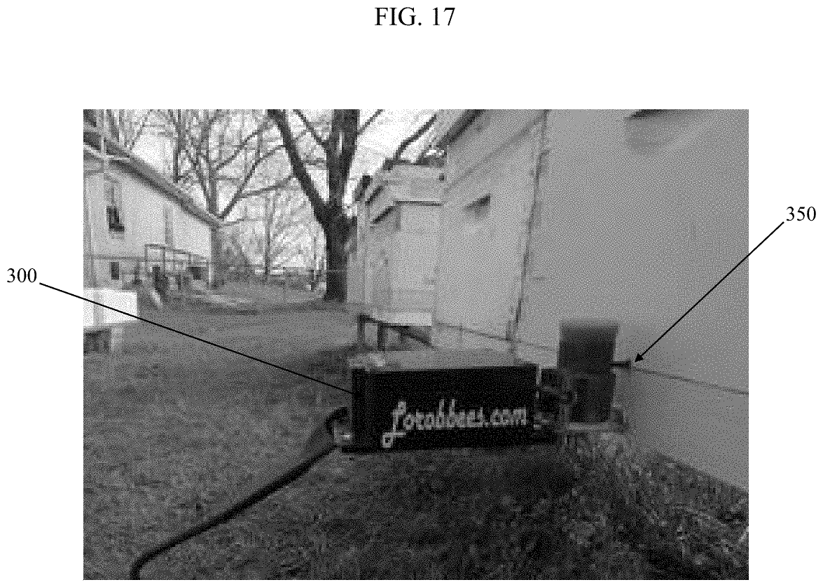

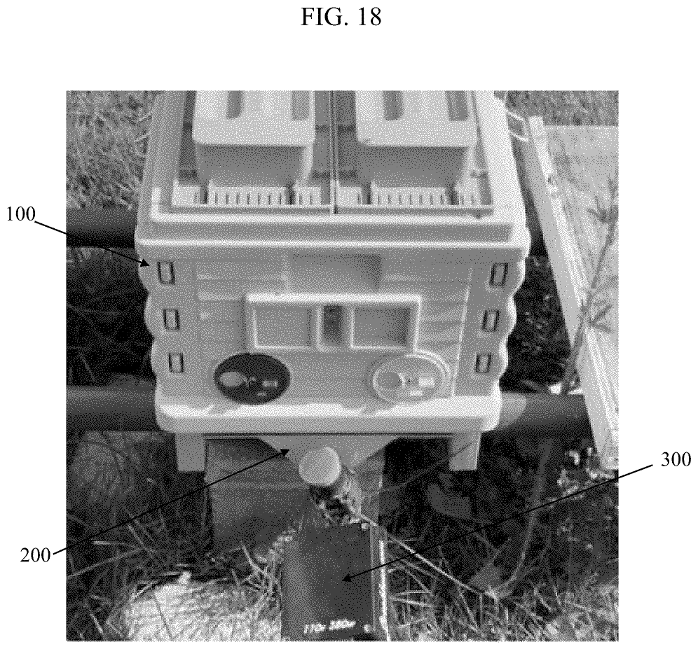

Referring now also to FIGS. 2-11, the adapter device 200 includes an adapter body 210 (e.g., a flat plate 210) having at least one hive engagement feature 220A,220B (e.g., side edges 220A,220B of the plate 210); at least one manipulation feature 230 (e.g., a lip 230 for gripping a front of the plate 210); and a recess 240 providing a reservoir 250 (e.g., a space for the hot acid vapor to gather) below the hive 100, the reservoir 250 being open to an interior of the hive 100, the recess 240 including a port 260 (e.g., a through hole 260) configured to accommodate a vaporizer output 350 (e.g., a nozzle 350) of a vaporizer 300 (see FIGS. 17 and 18).

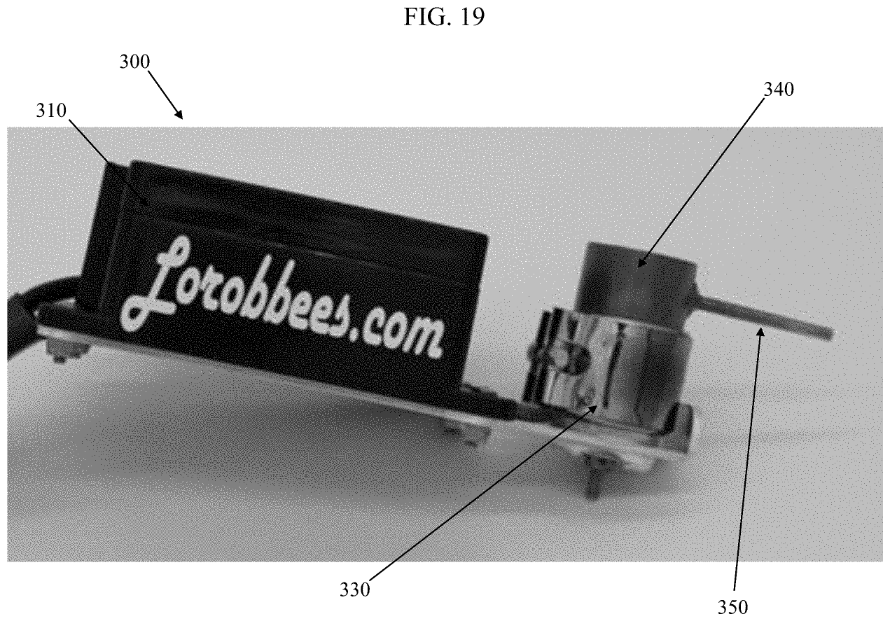

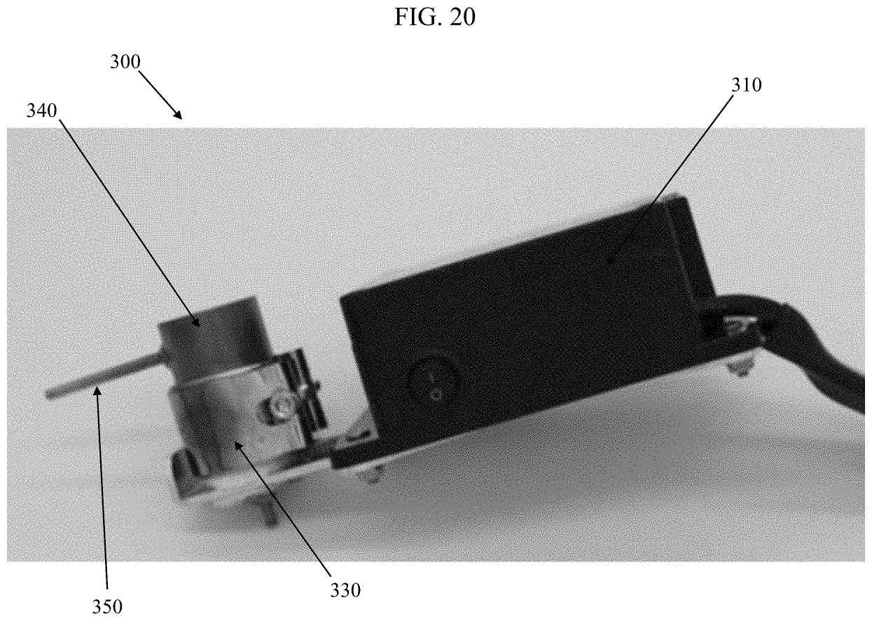

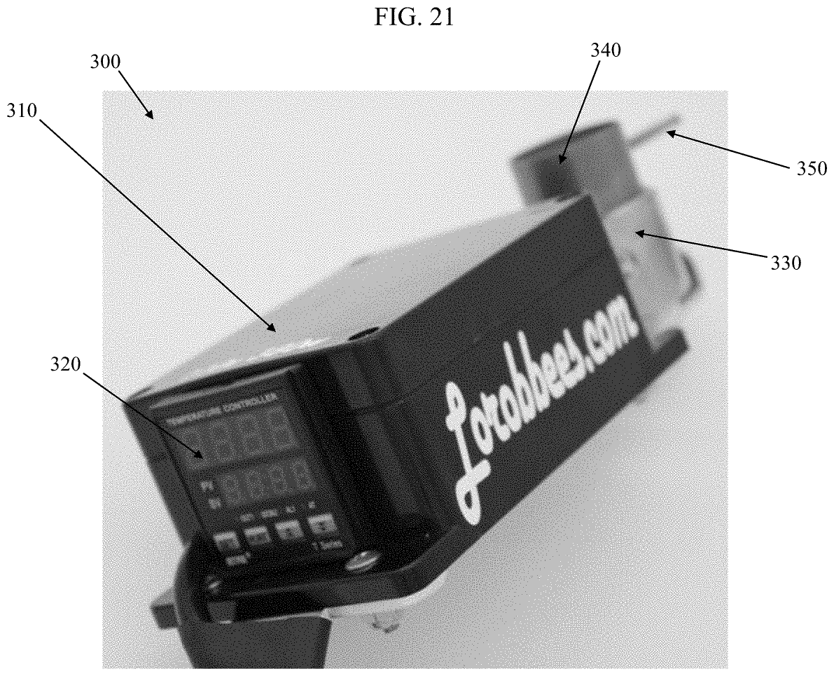

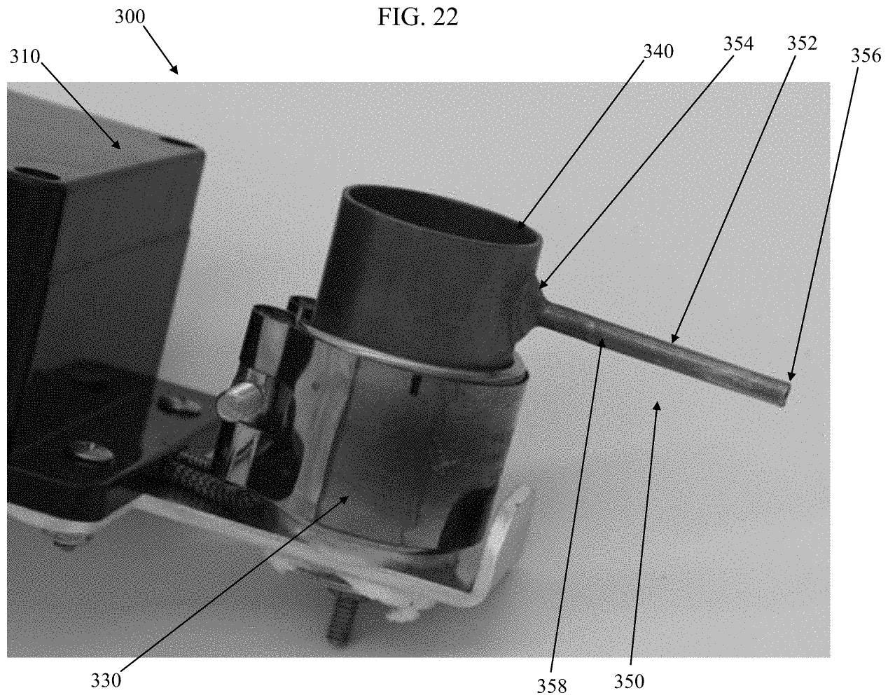

Referring now also to FIGS. 19-22, the vaporizer 300 is shown in right side (FIG. 19), left side (FIG. 20), back perspective (FIG. 21) and front close-up (FIG. 22) views. The vaporizer 300 includes a vaporizer body 312 including circuitry (not visible, inside the body 312), controls 320, a heating element 330, and an oxalic acid reservoir 340.

The vaporizer 300 further includes, extending from the oxalic acid reservoir 340, an efficient delivery output of a preferred embodiment of the present invention.

In preferred embodiments, the efficient delivery output includes an output body with a proximal end and a distal end and an oxalic acid vapor passageway extending therebetween. Preferably, the proximal end is configured to direct and concentrate oxalic acid vapors received from an oxalic acid reservoir. Preferably, the distal end is configured to deliver the concentrated oxalic acid vapors to a central area of a beekeeping device, such as, for example, a central area of a reservoir of an adapter body of a vaporizer adapter plate.

An example of a preferred embodiment of the efficient delivery output of the present invention is illustrated in FIGS. 19-22. The illustrated efficient delivery output (e.g., nozzle 350) has an output body (e.g., nozzle body 352) with a proximal end (e.g., proximal end 354) and a distal end (e.g., distal end 356) and an oxalic acid vapor passageway (e.g., conduit 358) extending therebetween.

The proximal end 354 has a conical shape with a large diameter, at an opening that receives oxalic acid vapors from the oxalic acid reservoir 340, that tapers to a small diameter. The large diameter is preferably approximately 1 inch wide. The small diameter is preferably smaller than a diameter of the port 260 of the vaporizer adapter device 200. Accordingly, the proximal end 354 is configured to direct and concentrate oxalic acid vapors received from the oxalic acid reservoir 340.

The distal end 356 has a tubular shape with a preferably consistent diameter that is preferably equal to the small diameter, and has a length that is dimensioned to extend through the port 260 of the vaporizer adapter device 200 and into a central area of the reservoir 250 of the vaporizer adapter device 200.

Accordingly, the distal end 356 is configured to deliver the concentrated oxalic acid vapors to a central area of the beekeeping device 100, such as, for example, a central area of the reservoir 250 of the adapter body 210 of the vaporizer adapter device 200.

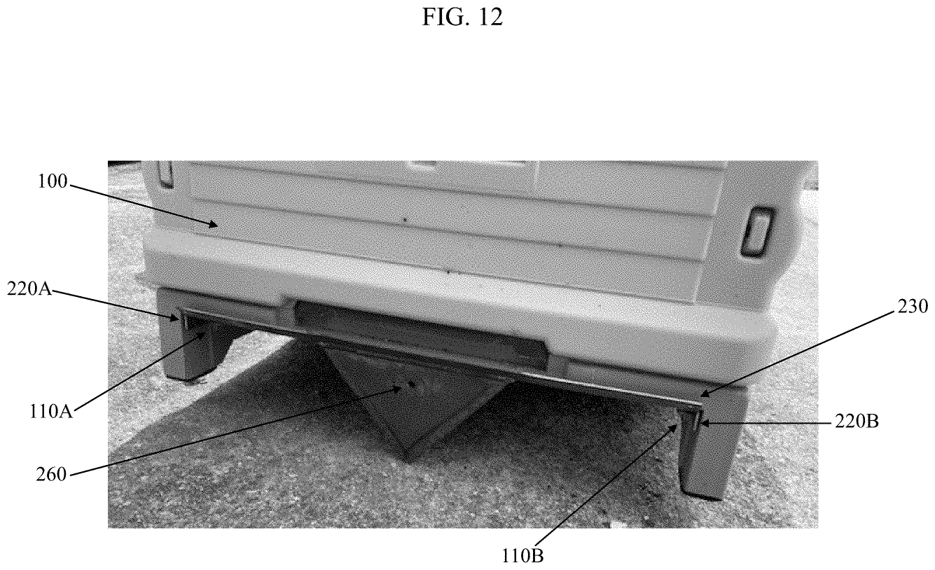

The illustrated hive 100 has lateral protrusions 110A,110B (e.g., (e.g., ledges 110A,110B, best seen in FIG. 12), and the hive engagement feature 220A,220B includes lateral edges 220A,220B that slidably engage with the protrusions 110A,110B.

The protrusions 110A,110B extend inwardly (e.g., ledges 110A,110B extending inwardly from interior walls of the hive bottom), and the edges 220A,220B slide on the protrusions 110A,110B.

Further, the adapter body 210 is planar, the edges 220A,220B extend non-parallel to the adapter body 210 (e.g., bend downward relative to the body of the plate 210), and ends of the edges 220A,220B (e.g., downwardly extending ends of the edges 220A,220B) slide on the protrusions 110A,110B.

The manipulation feature 230 includes a lip 230 that extends outwardly from the hive 100 (e.g., is outside the hive 100) when the device 200 is installed in the hive 100.

The adapter body 210 is planar and the lip 230 extends non-parallel to the body 210 (e.g., bends upwards and away from the body of the plate 210).

The reservoir 250 has a pyramid shape with a base 252 of the pyramid shape being open to the interior of the hive 100.

The pyramid shape has a height of between 3 inches and 3.5 inches.

The pyramid shape is a triangular pyramid shape.

Further, a base 252 of the triangular pyramid shape is an isosceles triangle.

Still further, the isosceles triangle has a height of 5 inches and a width of about 5.0625 inches.

It should be understood that the efficient delivery output of the present invention can be used with reservoirs of other shapes and dimensions.

The port 260 includes a hole 260 (e.g., a through hole 260) leading from an exterior surface of the recess 240 to an interior surface of the recess 240.

The hole has a diameter of between 0.15 inches and 0.45 inches.

It should be understood that the efficient delivery output of the present invention can be used with ports of other shapes and dimensions.

### Vaporizer Embodiments

In other example embodiments of the present general inventive concept, the invention provides an oxalic acid vaporizer that includes an efficient delivery output.

Referring again to FIGS. 17-22, an example embodiment of an oxalic acid vaporizer according to the present general inventive concept includes an efficient delivery output.

The vaporizer 300 includes a vaporizer body 310 including circuitry (not visible, inside the body 310), controls 320, a heating element 330, and an oxalic acid reservoir 340.

The vaporizer 300 further includes, extending from the oxalic acid reservoir 340, an efficient delivery output.

In preferred embodiments of the vaporizer, the efficient delivery output includes an output body with a proximal end and a distal end and an oxalic acid vapor passageway extending therebetween. Preferably, the proximal end is configured to direct and concentrate oxalic acid vapors received from an oxalic acid reservoir. Preferably, the distal end is configured to deliver the concentrated oxalic acid vapors to a central area of a beekeeping device, such as, for example, a central area of a reservoir of an adapter body of a vaporizer adapter plate.

In the illustrated vaporizer, the efficient delivery output (e.g., nozzle 350) has an output body (e.g., nozzle body 352) with a proximal end (e.g., proximal end 354) and a distal end (e.g., distal end 356) and an oxalic acid vapor passageway (e.g., conduit 358) extending therebetween.

The proximal end 354 has a conical shape with a large diameter, at an opening that receives oxalic acid vapors from the oxalic acid reservoir 340, that tapers to a small diameter. The large diameter is preferably approximately 1 inch wide. The small diameter is preferably smaller than a diameter of the port 260 of the vaporizer adapter device 200. Accordingly, the proximal end 354 is configured to direct and concentrate oxalic acid vapors received from the oxalic acid reservoir 340.

The distal end 356 has a tubular shape with a preferably consistent diameter that is preferably equal to the small diameter, and has a length that is dimensioned to extend through the port 260 of the vaporizer adapter device 200 and into a central area of the reservoir 250 of the vaporizer adapter device 200.

Accordingly, the distal end 356 is configured to deliver the concentrated oxalic acid vapors to a central area of the beekeeping device 100, such as, for example, a central area of the reservoir 250 of the adapter body 210 of the vaporizer adapter device 200.

Operation of the vaporizer with the efficient delivery output in use with a beekeeping device having a vaporizer adapter plate will now be described.

The vaporizer adapter device is installed by engaging the hive engagement feature of the adapter body with the hive using the hive manipulating feature to install the vaporizer adapter device in the hive such that the reservoir is open to an interior of the hive. Then, the efficient delivery output of the vaporizer is passed through the port and the vaporizer is operated to apply the treatment such that the hot acid vapors are, due to the configuration of the efficient delivery output, concentrated and delivered to a central area of the reservoir and accordingly pass into the interior of the hive, killing any varroa mites.

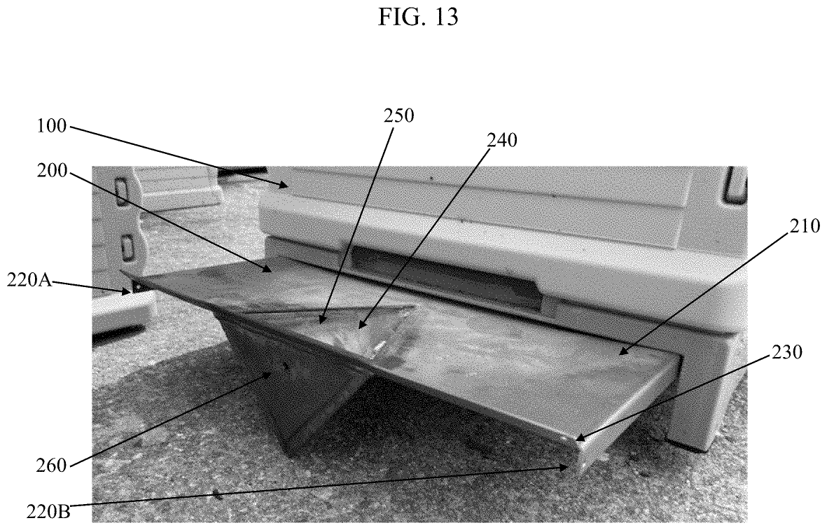

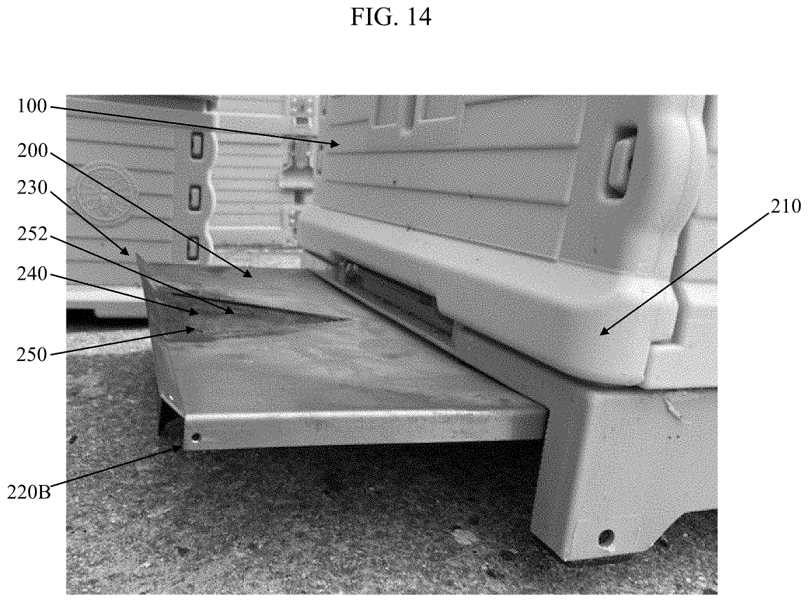

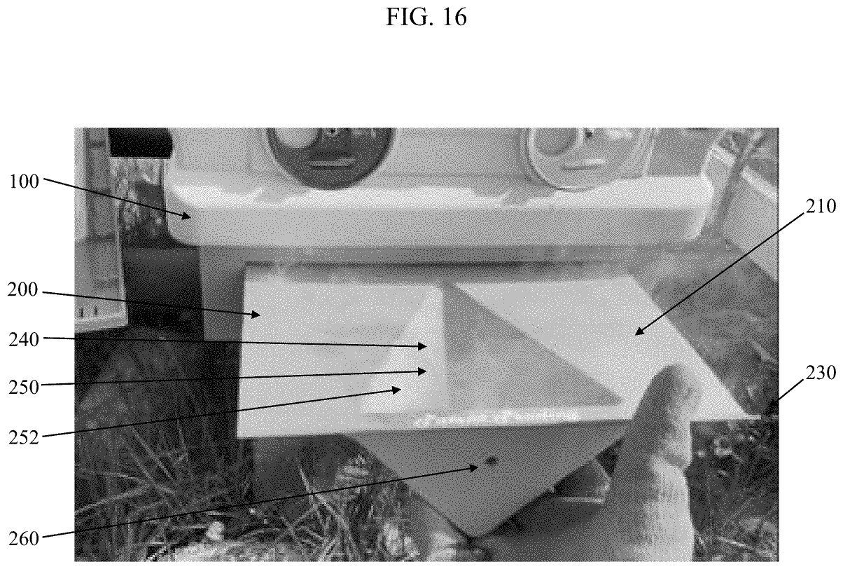

As an example operation, and referring now also to FIGS. 12-22, the vaporizer adapter device 200 is installed by sliding the lateral edges 220A,220B of the adapter plate 210 onto the lateral protrusions 110A,110B of the hive 100 using the lip 230 of the adapter plate 210 to install the vaporizer adapter device 200 in the hive 100 at the hive bottom such that the reservoir 250 is open from above to an interior of the hive 100. Then, the distal end 356 of the efficient delivery output 350 of the vaporizer 300 is passed through the port 260 and the vaporizer 300 is operated to apply the treatment such that the hot acid vapors are, due to the configuration of the efficient delivery output 350, concentrated and delivered to a central area of the reservoir 250 and then pass upwardly into the interior of the hive 100, killing any varroa mites.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. An efficient vaporizer output, for an oxalic acid vaporizer, for engagement with a hive-mounted vaporizer adapter device for a beekeeping device, the vaporizer output comprising:
an output body having a proximal end and a distal end, and
an oxalic acid vapor passageway extending between the proximal end and the distal end; wherein
the proximal end is configured to direct and concentrate oxalic acid vapors received from an oxalic acid reservoir of the oxalic acid vaporizer; and
the distal end is configured to deliver the concentrated oxalic acid vapors to a central area of the beekeeping device.

2. The device of claim 1, wherein the proximal end has a conical shape with a large diameter, at an opening that receives the oxalic acid vapors from the oxalic acid reservoir, that tapers to a small diameter.

3. The device of claim 2, wherein the small diameter is smaller than a diameter of a vaporizer output port of the vaporizer adapter device.

4. The device of claim 1, wherein the distal end has a tubular shape with a substantially consistent diameter smaller than a diameter of a vaporizer output port of the vaporizer adapter device and a length that is dimensioned to extend through the vaporizer output port and into a central area of a reservoir of the vaporizer adapter device.

5. An oxalic acid vaporizer for engagement with a hive-mounted vaporizer adapter device for a beekeeping device, the vaporizer comprising a vaporizer body, a heating element, an oxalic acid reservoir and an efficient delivery output, the output comprising:
an output body having a proximal end and a distal end, and
an oxalic acid vapor passageway extending between the proximal end and the distal end; wherein
the proximal end is configured to direct and concentrate oxalic acid vapors received from the oxalic acid reservoir; and
the distal end is configured to deliver the concentrated oxalic acid vapors to a central area of the beekeeping device.

6. The device of claim 5, wherein the proximal end has a conical shape with a large diameter, at an opening that receives the oxalic acid vapors from the oxalic acid reservoir, that tapers to a small diameter.

7. The device of claim 6, wherein the small diameter is smaller than a diameter of a vaporizer output port of the vaporizer adapter device.

8. The device of claim 5, wherein the distal end has a tubular shape with a substantially consistent diameter smaller than a diameter of a vaporizer output port of the vaporizer adapter device and a length that is dimensioned to extend through the vaporizer output port and into a central area of a reservoir of the vaporizer adapter device.

9. A combination of a hive-mounted vaporizer adapter device for a beekeeping hive, and an efficient delivery output cooperating therewith, the vaporizer output comprising:
an output body having a proximal end and a distal end, and
can oxalic acid vapor passageway extending between the proximal end and the distal end; wherein
the proximal end is configured to direct and concentrate oxalic acid vapors received from an oxalic acid reservoir of an oxalic acid vaporizer; and
the distal end is configured to deliver the concentrated oxalic acid vapors to a central area of the beekeeping hive;
the vaporizer adapter device comprising:
an adapter body having
at least one hive engagement feature;
at least one manipulation feature; and
a recess providing a reservoir below the hive, the reservoir being open to an interior of the hive, the recess including a vaporizer output port configured to accommodate the efficient delivery output.

10. The combination of claim 9, wherein the proximal end has a conical shape with a large diameter, at an opening that receives the oxalic acid vapors from the oxalic acid reservoir, that tapers to a small diameter.

11. The combination of claim 10, wherein the small diameter is smaller than a diameter of the vaporizer output port of the vaporizer adapter device.

12. The combination of claim 9, wherein the distal end has a tubular shape with a substantially consistent diameter smaller than a diameter of the vaporizer output port of the vaporizer adapter device and a length that is dimensioned to extend through the vaporizer output port and into a central area of the reservoir of the vaporizer adapter device.

13. The combination of claim 9, wherein the hive has lateral protrusions, and the hive engagement feature includes lateral edges that slidably engage with the protrusions.

14. The combination of claim 13, wherein the protrusions extend inwardly, and the edges slide on the protrusions.

15. The combination of claim 14, wherein the adapter body is planar, the edges extend non-parallel to the adapter body, and ends of the edges slide on the protrusions.

16. The combination of claim 9, wherein the manipulation feature includes a lip that extends outwardly from the hive when the device is installed in the hive.

17. The combination of claim 16, wherein the adapter body is planar and the lip extends non-parallel to the body.

18. The combination of claim 9, wherein the reservoir has a pyramid shape with a base of the pyramid shape being open to the interior of the hive.

19. The combination of claim 18, wherein the pyramid shape is a triangular pyramid shape.

20. The combination of claim 9, wherein the port includes a hole leading from an exterior surface of the recess to an interior surface of the recess.
